(19) United States
(12) Patent Application Publication
(10) Pub. No.: US 2002/0122524 A1
(43) Pub. Date: Sep. 5, 2002

(54) Method of reinforcing reactor core spray sparger

(75) Inventors: Shigeki Ohno, Ibaraki (JP); Nobuo Tada, Ibaraki (JP); Minoru Maeda, Ibaraki (JP)

Correspondence Address: Evenson, Mckeown, Edwards & Lenehan P.L.L.C., Suite 700, 1200 G St., N.W., Washington, DC, 20005, US

(73) Assignee: Hitachi, Ltd.

(21) Appl. No.: 09/928,507

(22) Filed: Aug. 14, 2001

(30) Foreign Application Priority Data
Feb. 28, 2000 (JP) 2000-055955

(51) Int. Cl. G21C 19/00

(52) U.S. Cl. 376/261

(57) ABSTRACT

A socket is mounted to each end plate of a reactor core spray sparger, and a support having the structure of supporting said sockets is mounted by pushing against said sockets mounted to end plates facing each other with a jack. By this, the end plates of a reactor core spray sparger can be reinforced with ease.

### BACKGROUND OF THE INVENTION

The present invention relates to a method of reinforcing end plates of a reactor core spray sparger, which is a structure inside a nuclear reactor.

As a preventive maintenance of structures inside an established nuclear reactor constituted from materials having relatively high sensitivity towards stress-corrosion cracking, methods such as lowering residual stress by executing peening to the vicinity of the welded portion, as is disclosed in Japanese Patent Laid-Open No. H8-071919, or relaxing the corrosion environment by injecting hydrogen, as is disclosed in Japanese Patent Laid-Open No. H5-148674, or the like have been proposed heretofore. Also, as is disclosed in Japanese Patent Laid-Open No. H9-292486 or Japanese Patent No. 2,766,179, a method of replacing all the structures inside the nuclear reactor with materials having low sensitivity towards stress-corrosion cracking have been proposed.

### SUMMARY OF THE INVENTION

In a boiling water reactor, a reactor core spray sparger is provided in order to inject cooling water uniformly to the reactor core in case of emergency. The reactor core spray sparger is constituted from four semiarc pipes installed with a plurality of nozzles, and is mounted to the inner surface of the upper barrel of the reactor shroud so that two reactor core spray spargers are positioned one above the other, and the other two is point-symmetrically positioned based on the center of the reactor shroud relative to the first two. The end portions of each of the pipes are sealed with end plates, which are mounted to the pipes by welding.

When a stress-corrosion cracking occurs at the vicinity of the welded portion of the end plate, there is a possibility that the end plate might break and damage the fuel and the like. Moreover, if the end plate is broken, there is a possibility that water cannot be injected uniformly to the reactor core, when injecting water in case of emergency.

As is disclosed in the above-mentioned prior art, various preventive maintenance methods for restraining stress-corrosion cracking have been proposed. However, the improvement effect of the corrosion environment by injection of hydrogen is small at the region where cooling water comes to a boil and bubbles are generated, therefore it is considered desirable to perform another preventive maintenance to the reactor core spray sparger located in the region. Moreover, it is difficult to approach a device to the inner surface of the reactor core spray sparger, therefore measures such as removing some portions of the pipes must be taken in order to execute peening. When the structures inside the nuclear reactor, such as a reactor shroud or the like, are replaced, the reactor core spray sparger can be replaced with structural materials excelling in anticorrosive property. However, this involves extensive work, and the plant must be shut down for a long time.

The object of the present invention is to provide a reinforcing method to prevent breaking of the end plates of the reactor core spray sparger, which cannot be performed easily with preventive maintenance of the prior art.

In order to accomplish the above-mentioned object, a support is fixed to the end plates of the reactor core spray sparger by mechanical fastening.

With such structure, the end plate is held in its position by the support, even when the vicinity of the welded portion of the end plate is cracked along its entire periphery, so that the end plate does not break down. Also, the function of injecting cooling water uniformly in case of emergency can also be maintained.

### BRIEF DESCRIPTION OF THE DRAWINGS

FIG. 1 is a view indicating the situation where the reinforcing support is mounted to the end plates of the reactor core spray sparger;

FIG. 2 is a view indicating the cross-section of the nuclear reactor pressure vessel;

FIG. 3 is a view indicating the structure of the reactor core spray sparger; and

FIG. 4 is a view indicating the condition where the reinforcing support is mounted to the end plates of the reactor core spray sparger.

### DETAILED DESCRIPTION OF PREFERRED EMBODIMENTS

### Embodiment 1

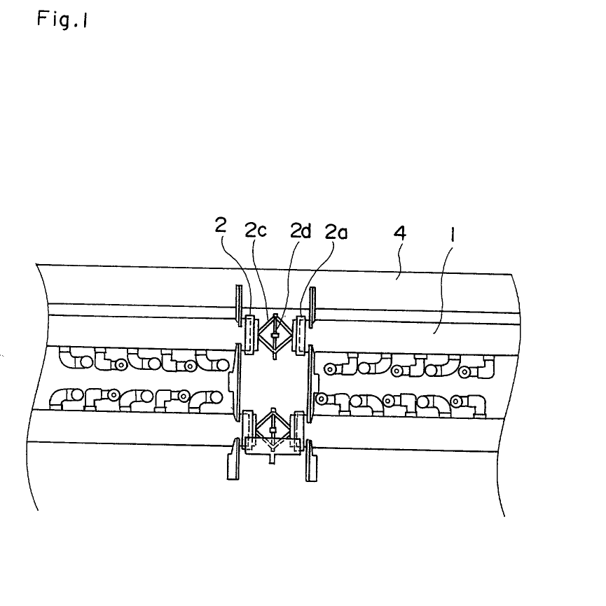

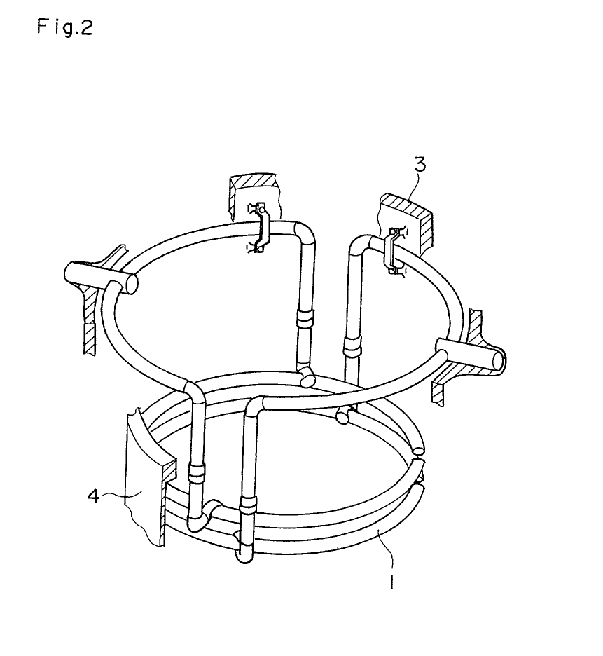

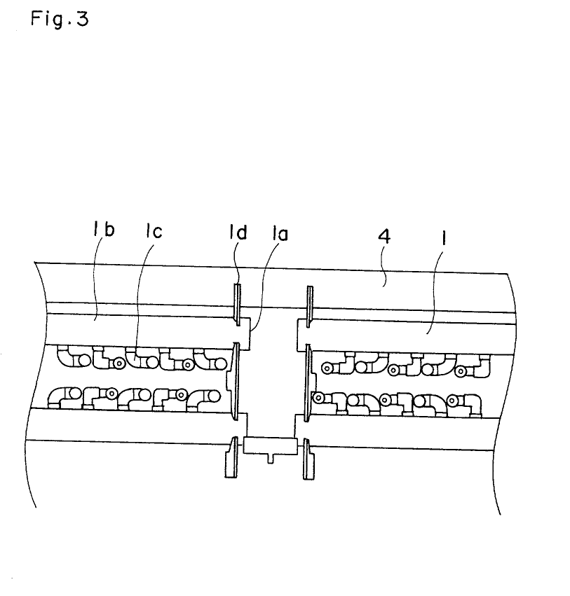

The first embodiment of the present invention will be described hereinafter with reference to FIG. 1 through FIG. 3. FIG. 1 shows a situation where the support 2 according to the present invention is mounted, FIG. 2 is a bird's-eye view of the reactor core spray sparger 1 and the piping inside a nuclear reactor pressure vessel 3, and FIG. 3 is a structural view of the reactor core spray sparger 1 as an object of the present invention.

As is shown in FIG. 3, a reactor core spray sparger 1 is constituted from a header 1b and spray nozzles 1c. A total of four reactor core spray spargers 1 are supported by a plurality of support brackets 1d along the inner surface of a reactor shroud upper barrel 4, with two positioned one above the other, and another two positioned in bilateral symmetry thereto. Both ends of the header 1 are sealed by end plates 1a, with end plates 1a at each height facing each other, respectively.

In the present invention, a support 2 is installed between each of the facing end plates 1a to support the end plates 1a, as is shown in FIG. 1. The support 2 is constituted from sockets 2a at both ends thereof, a jack 2c for connecting each of the sockets 2a, and an adjust screw 2d for adjusting the length of the jack 2c. The socket 2a fits against the end surface of the header 1b, and has the structure of possessing a ring at the periphery thereof. The ring has a slightly larger inner diameter than the outer diameter of the header 1b, so that the socket 2a does not drop even when the jack 2c somewhat loosens. A plurality of claws may be used in place of the ring.

In mounting the support 2, the positioning of the sockets 2a are carried out with the jack 2c in the shortened condition, and the support 2 is mounted by screwing the adjust screw 2d to elongate the jack 2c until the sockets 2a come into contact with the end plates 1a. It may be carried out so that each socket is added with an appropriate load to push each other away. Then, a whirl-stop welding of the adjust screw 2d is performed. A whirl-stop cap may be used to whirl-stop the adjust screw 2d. Also, two sockets 2a positioned one above the other may be connected in one body, and the connected sockets 2a may be mounted at once.

### Embodiment 2

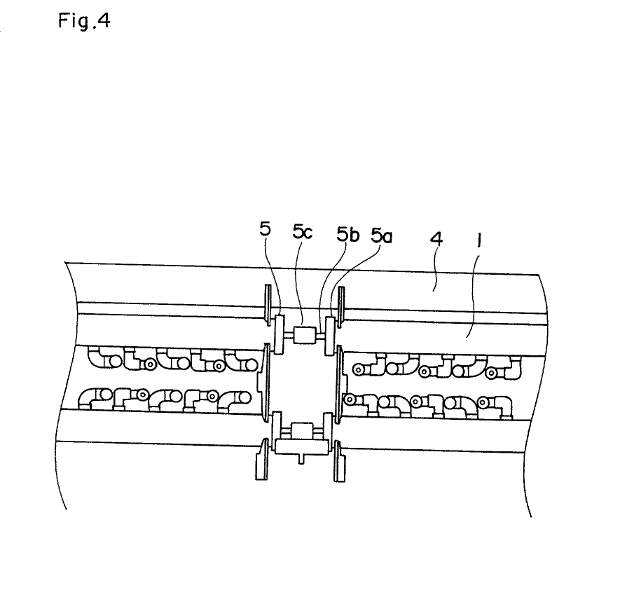

Next, the second embodiment of the present invention will be described with reference to FIG. 4. In the present invention, a support 5 is installed between the facing end plates 1a to support the end plates 1a, as is shown in FIG. 4. The support 5 is constituted from sockets 5a at both ends thereof, rods 5b, and a sleeve 5c made of shape memory alloy for connecting the rods 5b. The inner diameter of the sleeve 5c is larger than the outer diameter of the rod 5b when cold. The diameter of the sleeve 5c shrinks when heated and fastens the rods 5b.

The support 5 is mounted with the process mentioned below. First, the sockets 5a are pressed against respective end plates 1a. At this point, the sleeve 5c being pierced by one of the rods 5b is moved to the side of the socket 5a installed to the rod 5b, so that it does not inhibit mounting of the other socket 5a and the rod 5b. Then, the position of the sleeve 5c is shifted to fit with the rod 5b of the other socket 5a, and the sleeve 5c is heated to shrink and deform in the radius direction to connect the rods 5b.

According to the present invention, preventive maintenance of the reactor core spray sparger could be performed with ease.

We claim:

1. A method of reinforcing a reactor core spray sparger, comprising mounting a socket to each end plate of a reactor core spray sparger, which is a structure inside a nuclear reactor of a boiling water reactor plant, and mounting a support having the structure of supporting said sockets by pushing against said sockets mounted to end plates facing each other with a jack.

2. A method of reinforcing a reactor core spray sparger according to claim 1, wherein a support for connecting sockets fitted to end plates facing each other is mounted using a sleeve made of shape memory alloy as said jack.
